(19) United States
(12) Patent Application Publication
(10) Pub. No.: US 2023/0147314 A1
(43) Pub. Date: May 11, 2023

(54) A METHOD OF PREPARING DOPE DYED LYOCELL FIBRE

(71) Applicant: ADITYA BIRLA SCIENCE AND TECHNOLOGY COMPANY PRIVATE LIMITED, Navi Mumbai (IN)

(72) Inventors: Vivek GANVIR, Navi Mumbai (IN); Santosh REVANKAR, Navi Mumbai (IN); Dhirendra SINGH, Navi Mumbai (IN); Shirish THAKRE, Navi Mumbai (IN); Sachin JADHAV, Navi Mumbai (IN)

(21) Appl. No.: 17/916,246

(22) PCT Filed: Feb. 18, 2021
(86) PCT No.: PCT/IN2021/050152

§ 371 Date: Sep. 30, 2022

(30) Foreign Application Priority Data
Mar. 31, 2020 (IN) 202021014383

(51) Int. Cl. D01F 2/02; D01F 1/04; D01D 5/06

(52) U.S. Cl. CPC D01F 2/02; D01F 1/04; D01D 5/06; D10B 2201/22; D10B 2401/14

(57) ABSTRACT

A process for obtaining a dope dyed lyocell fibre can include the steps of (a) mixing one or more pigment with an aqueous organic solvent to obtain a slurry; (b) applying vacuum to said slurry to remove excess water content to obtain a masterbatch (c) mixing the masterbatch obtained in step (b) to a lyocell dope to obtain a pigmented dope; and (d) extruding said pigmented dope of step (c) through a spinneret to form dope dyed lyocell fiber.

### FIELD OF THE INVENTION

The present invention relates to a method of preparing dope dyed lyocell fibre.

### BACKGROUND OF THE INVENTION

Lyocell fibre manufacturing process is an eco-friendly process and an environmentally benign alternative to the viscose fibre manufacture process, for the production of high-end cellulose fibres. Moreover, manufacturing of lyocell fibre requires sustainable natural resource and it does not even produce liquid waste therefore it is known as green and sustainable technology.

These conventional methods for producing Lyocell fibres includes following four steps: mixing, dissolving, spinning, and washing. The Lyocell process uses a direct solvent, N-Methyl-Morpholine N-Oxide (NMMO), in the production of Lyocell fibres to dissolve cellulose from pulp resulting in formation of cellulose dope. This cellulose dope is spun into cellulosic fibres leaving behind a spent NMMO solution. To economise the process, spent NMMO solution (referred hereinafter as spin bath NMMO solution), is recovered and recycled after purifying it.

Generally, the grey fibre used for making fabrics mostly required dyeing process which requires huge amount of water and cause water pollution. Pigments can be added to the spinning solution if coloured fibres are desired. Homogenous dispersion of the pigment is crucial for getting desired properties. Pigments in general and specifically carbon black is inherently difficult to disperse, and a dispersing agent is used to enable good dispersion and avoid agglomeration. The ability of the fibre to attain the desired colour or shade depends on the distribution pattern of the pigment into the fibres. Pigments that are not stable in the alkaline dope conditions may form unstable dispersion, agglomerate, and/or clump together.

Safety, uniform pigment dispersion and ease of production in batches are some of challenges which could be solved in this innovation. Therefore, there is a need of a method that overcomes the problems.

### SUMMARY OF THE INVENTION

In an aspect, there is provided a process for preparing a dope dyed lyocell fibre. In the process a pigment masterbatch is prepared by mixing one or more pigment with an aqueous organic solvent. Subsequently excess water from pigment masterbatch is removed by applying vacuum. The pigment masterbatch obtained have 8-15% water and 0.4 to 15% pigment. The process further comprises of mixing the pigment masterbatch with a lyocell dope to obtain a pigmented dope. and the pigmented dope is extruded through a spinneret to form dope dyed lyocell fiber.

In another aspect, a dope dyed lyocell fibre is prepared by mixing cellulose pulp and at least one pigment in an aqueous organic solvent to obtain a cellulosic dope. The cellulose dope is further subjected to evaporation to remove excess water content to obtain a pigmented dope. The pigmented dope is extruded through a spinneret to form dope dyed lyocell fiber.

### BRIEF DESCRIPTION OF DRAWINGS

FIG. 1 illustrates a flow diagram of second manufacturing of dope dyed lyocell fibre, in accordance with the present invention;

FIG. 2 illustrates a flow diagram of First manufacturing method of dope dyed lyocell fibre, in accordance with an embodiment of the present invention;

FIG. 3 shows black dyed cellulose dope in NMMO and post regeneration bath image showing no leaching of dye, in accordance with an embodiment of the present invention;

FIG. 4 depicts a TGA-DSC curve for black dyed cellulose dope in NMMO as shown in FIG. 4, in accordance with another embodiment of the present invention; and

FIG. 5 illustrates blue dyed cellulose dope in NMMO and post regeneration bath image showing no leaching of dye, in accordance with the embodiments of the present invention.

### BRIEF DESCRIPTION OF THE EMBODIMENTS

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described herein. As used herein, each of the following terms has the meaning associated with it in this section. Specific and preferred values listed below for individual process parameters, substituents, and ranges are for illustration only; they do not exclude other defined values or other values falling within the preferred defined ranges.

As used herein, the singular forms “a,” “an,” and “the” include plural reference unless the context clearly dictates otherwise.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention

As used herein, the terms “comprising” “including,” “having,” “containing,” “involving,” and the like are to be understood to be open-ended, i.e. to mean including but not limited to.

While the present invention is susceptible of embodiment in various forms, there is hereinafter described a presently preferred embodiment with the understanding that the present disclosure is to be considered an exemplification of the invention and is not intended to limit the invention to the specific embodiment illustrated.

To overcome the limitations of art, the present invention provides a process for preparing dope dyed Lyocell fibres comprising the steps of:
a. mixing one or more pigment with an aqueous organic solvent to obtain a slurry;
b. applying vacuum at a predetermined temperature to said slurry to remove excess water content to obtain a masterbatch comprising 8-15% water and 0.4 to 15% pigment
c. mixing the masterbatch obtained in step (b) to a lyocell dope to obtain a pigmented dope; and
d. extruding said pigmented dope of step (c) through a spinneret to form dope dyed lyocell fiber.

In an embodiment, the lyocell dope is a cellulose pulp dissolved in N-methylmorpholine-N-oxide. In another embodiment, said aqueous organic solvent is N-methylmorpholine-N-oxide. In another embodiment, the pigment is at least one color pigment selected from group consisting of green, blue, red, black and/or yellow pigments.

During operation, 60-76% NMMO is mixed with regular dissolving grade pulp in pulper to get slurry of composition 10-12% cellulose, 50-68% NMMO. After making a uniform slurry, excess water is removed from the mixture by evaporation. The required amount of water is removed from the slurry to from dope of composition 12-13% cellulose, 76-77% NMMO. Further, a master batch is prepared by mixing pigment slurry containing 10-60% solid pigments in 60-76% NMMO to get a pigment NMMO mixture, excess water is removed from the mixture by applying vacuum 50-100 Torr at temperature of 90-105 ° C. to obtain NMMO in monohydrate form. The cellulosic dope is mixed with pigment master batch comprising 2-50% pigment in 86-87% NMMO to get dope with pigment.

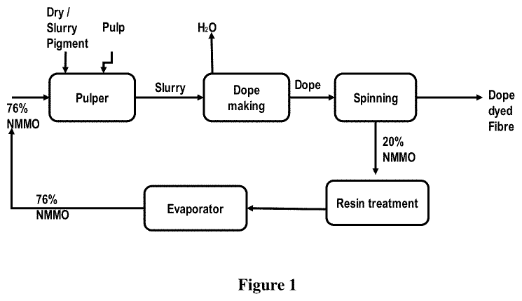

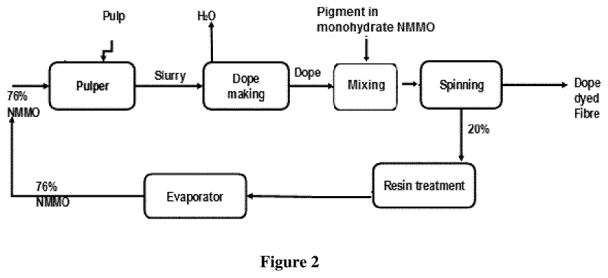

This pigmented dope with composition of 12-13% cellulose, 76-77% NMMO, 0.2-5% pigment is ready to be spun. As shown in FIG. 2, there is a need for separate mixing zone and dye/pigment slurry masterbatch is added. This method, define as master batch concept is suitable for batchwise production of dope dyed lyocell fibre. In another method of pigmented master batch preparation, wherein the pigment slurry, cellulose is mixed in 60-76% NMMO with 0.3% propyl gallate as antioxidant. This mixture is heated at temperature 100-105° C. under vacuum 50-100 Torr to remove excess water to get pigmented masterbatch with target cellulose concentration of 0.5-5% (w/w), pigment concentration of 0.4-12.6% (w/w) and 76-83% NMMO. 0.5-5% cellulose is added in to pigmented master batch to get better consistency for mixing with cellulosic dope. This pigmented master batch added in to dope as shown in FIG. 1 to get pigmented dope with composition of 12-13% cellulose, 76-77% NMMO, 0.1-5% pigment ready for spinning.

In another embodiment, the process for preparing a dope dyed lyocell fibre comprising the steps of:
preparing a cellulosic dope by mixing cellulose pulp and at least one pigment in an aqueous organic solvent; and
allowing evaporation of said cellulosic dope to remove excess water content to obtain a pigmented dope.
extruding the pigmented dope through a spinneret to form dope dyed lyocell fiber

During operation, dry/slurry pigments are added in pulper along with regular dissolving grade pulp and 60-76% NMMO. After mixing them properly, slurry with composition of 10-12% cellulose, 50-68% NMMO and 0.1 -2% pigment, is ready for making dope. After making a uniform slurry, excess water is removed from the mixture by evaporation. Required amount of water is removed from the slurry to from dope of composition 12-13% cellulose, 76-77% NMMO, 0.5 -5% pigment. This dope is ready for spinning. As describe in FIG. 2, the dye/pigment slurry is added at Pulper stage and uniform mixing done is at initial stage, defined as direct dissolution process. This method is suitable for continuous production of dope dyed lyocell fibre with a specific shade.

Dyed dope is then spun at a temperature of about 105 to 110° C. using dry jet wet spinning method. Herein, 20% NNMO-water solution is used as a regeneration bath for regeneration of cellulose. The concentration of regeneration bath is kept constant by circulating dilute NMMO. Further additional 20% NMMO form spin bath is recovered by resin treatment to remove impurities like metal ions. This resin treated 20% NMMO is then concentrated to 76% NMMO using evaporator. This can be reused as a solvent for fresh dope preparation with pigments.

The pigment formulation may be added in the beginning in 60-76% NMMO in pulper before dope preparation or is added in 87% NMMO as a master batch and then added to the dope after dope preparation.

### Advantages:

(a) No leaching of pigment observed in regeneration bath.
(b) Uniformed dope dyed lyocell fibre obtained. Pigment fibre composites to get uniform coloured fibre of various shaded and deniers.
(c) High strength as compare to dope dyed viscose. (in the range of 4 gpd & elongation of 10-15%). It will save water consumption due to dyeing process.
(d) Single step process to get a dope dyed fibre.
(e) Green processes compare to reactive dyeing (less water consumption, no leaching of dyes in effluent. Hazardous reactive dying vs non-hazardous pigments.

### WORKING EXAMPLES

Advantages and benefits of the present process according to the embodiments of the present invention would become more apparent from the below experimental details to a person skilled in the art.

### Example 1

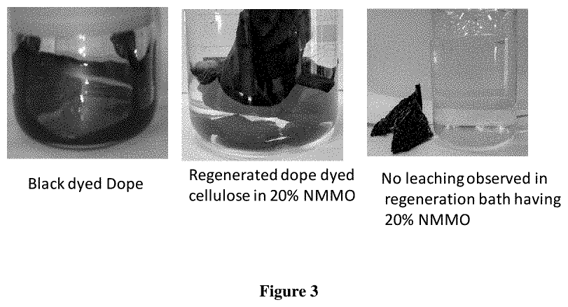

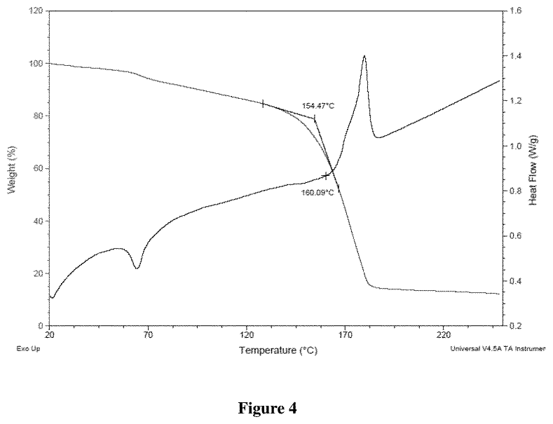

9.6% cellulose, 0.33% VBL black pigment 58% NMMO and rest water was mixed in sigma mixer with very high shearing. 0.3% of propyl gallate with respect to cellulose concentration was added which acts as antioxidant to protect cellulose from degradation. Excess water was removed from the mixture by applying vacuum 50-100 Ton at temperature of 90-105° C. to make black pigmented dope contained 12.55% Cellulose, 0.45% VBL, 76.2% NMMO and 10.8% water. FIG. 3 showed black pigmented lyocell dope. After regeneration of dope in 20% NMMO in water, no leaching of dye observed. FIG. 4 shows a TGA-DSC graph depicting onset temp of 155-160° C. for dyed dope which is 3-4° C. less than normal dope.

### Example 2

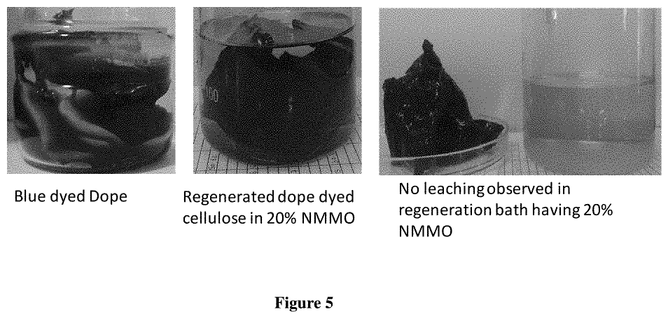

Blue pigmented dope of 500 g was prepared my mixing 62.75 g cellulose pulp, 4.49 g ARN blue pigment (49% pigment slurry), 0.19 g propyl gallate and 584 g of 65% NMMO in sigma mixer with very high shearing. Excess water was removed from the mixture by applying vacuum 50-100 Torr at temperature of 90-105° C. to make blue pigmented dope contained 12.55% cellulose, 0.45 blue ARN, 76.2% NMMO and 10.8% water. After regeneration of dope in 20% NMMO in water, no leaching of dye observed as shown in FIG. 5. Similarly, Red and yellow pigments dyed dope were also prepared with similar composition and no leaching of colour observed for them as well.

### Example 3

Dope prepared in Example 1 and Example 2 were spun at 105-110° C. using 100/300 holes spinneret of 100 micron diameter using dry wet spinning concept. Dope flow was set at 0.027 g/hole. The air gap of 22 mm was maintained with temperature and RH of 20-25° C. and 50-70% respectively. The spun filaments were regenerated in 20% NMMO spin bath at 20° C. and drawn at draw ratio of 10-12 to get coloured filaments. These filaments were cut, washed in hot water, dried to get coloured fibres. These fibres were tested for mechanical properties are listed in Table 1. It was observed that coloured pigments addition do not have significant effect on mechanical properties of the dope dyed lyocell fibre.

TABLE 1
Mechanical properties of dope dyed fibres

| | Pigment | | | | | | |
|---|---|---|---|---|---|---|---|
| | loading in | Denier | | Elongation | | Tenacity | |
| Colour | fibre (%) | (CV %) | | (CV %) | | (CV %) | |
| Yellow | 3.5 | 1.15 | (11.59) | 10.72 | (20.31) | 3.88 | (11.35) |
| Red | 3.5 | 1.1 | (13.68) | 13.84 | (13.27) | 4.21 | (15.33) |
| Blue | 3.5 | 1.34 | (16.32) | 11.95 | (10.92) | 4.17 | (8.52) |
| Black | 3.5 | 1.23 | (12.15) | 12.52 | (15.24) | 3.52 | (12.7) |
| Control | 0 | 1.2 | (6.3) | 9.9 | (27.1) | 4.2 | (10.4) |

### Example 4

Fibre colour properties of four dope dyed lyocell fibres prepared in Example 3 were tested for colour value (L, a, b) and evaluated for colour fastness to wash as per ISO:105 C10-2006 (B2). All samples showed excellent colour fastness to wash results are summarised in Table 2.

TABLE 2
Colour values and Colour fastness to wash results

| | | | | Colour fastness |
|---|---|---|---|---|
| Colour | L | A | b | (ISO: 105 C10-2006 (B2)) |
| Yellow | 74.92 | 0.79 | 75.47 | 4-5 |
| Red | 43.06 | 60.12 | 33.43 | 4-5 |
| Blue | 41.88 | −13.37 | −32.11 | 4-5 |
| Black | 15.2 | 0.29 | 0.14 | 4-5 |

### Example 5

A master batch of pigment can be added just before spinning zone and mixed properly as shown in FIG. 2. Blue and black pigments were used to prepare dope dyed fibre using this method. Initially Blue pigment master batch was prepared by mixing 0.1% ARN blue pigment, 51% NMMO and 48.9% water in rota-evaporator or sigma mixer. The excess water was removed by applying vacuum of 50-100 torr and at temperature of 90-105° C. to get master batch containing 14.8% pigment 75.2% NMMO and 10% water wherein NMMO is NMMO monohydrate. Regular dope with 13% cellulose, 76.0% NMMO, 10.8% water were prepared at 105° C. at very high shearing using sigma mixture. The pigmented master batch was added to dope present in sigma mixer. After addition of masterbatch in dope, it was mixed for 10-minute at 105° C. to obtained final dyed dope, ready for spinning. The mixing ratio of dope to master batch was fixed at 20:1 based on the targeted 3.5% (w/w) pigment with respect to fibre. Similar process was followed for preparing black dyed lyocell also. Comparison of physical properties of the dope dyed fibre made by direct process and masterbatch process are summarised in Table 3. Similar fibre properties were observed for both processes with excellent colour fastness.

TABLE 3
Comparison for fibre properties made by different processes

| | | | | | | | | | Colour |
|---|---|---|---|---|---|---|---|---|---|
| | | Pigment | | | | | | | fastness |
| Fibre | | loading | | | | | | | (ISO: 105 |
| Colour | Process | in fibre (%) | Denier | Elongation | Tenacity | L | A | b | C10-2006 (B2)) |
| Blue | Direct | 3.5 | 1.34 | 11.95 | 4.17 | 41.88 | −13.37 | −32.11 | 4-5 |
| Black | Direct | 3.5 | 1.23 | 12.52 | 3.52 | 15.2 | 0.29 | 0.14 | 4-5 |
| Blue | Master | 3.5 | 1.31 | 11.67 | 4.24 | 41.01 | −13.91 | −32.34 | 4-5 |
| | Batch | | | | | | | | |
| Black | Master | 3.5 | 1.32 | 10.72 | 3.84 | 14.8 | 0.35 | 0.23 | 4-5t |
| | Batch | | | | | | | | |

### Example 6

In continuous production process master batch with pigment can be made by dispersing colour pigment in NMMO -water system and make monohydrate of NMMO by removing excess water from the solution. Pigment concentration in monohydrate masterbatch may be in the range 0.2-15% (w/w). This master batch is added in cellulosic dope in NMMO-water system as per requirement in required ratio using static/ dynamic mixer. The master batch was mixed with control dope of 13% cellulose in NMMO-water system in ratio of control: master batch is around 20-35 using sigma mixer. The final dope quality after mixing was good and fibre spinning performance was like regular control dope. For 0.1% concentration of red pigment in fibre, master batch of 0.4% pigment in NMMO monohydrate prepared by mixing 0.3% pigment in 65% NMMO and 34.75 water in sigma mixer and removed excess water at 105° C. under vacuum. The master batch was mixed with control dope in 31:1 (control dope to MB). Similarly another dope was also prepared using 13% & 15% pigmented masterbatches. All three dopes were spun in to fibre as per standard process. For lighter to darker shades, colour values and washing fastness are provided in Table 4.

TABLE 4
Properties of various shades of fibre prepared by master batch approach

| | | | | | | | Colour |
|---|---|---|---|---|---|---|---|
| | | Mixing | | | | | fastness |
| | Pigment | ratio | Pigment | | | | (ISO: 105 |
| Colour | in MB (%) | (control:MB) | in fibre (%) | L | a | B | C10-2006 (B2)) |
| Red | 0.4 | 31 | 0.1 | 60.31 | 31.52 | 1.81 | 4-5 |
| Red | 13 | 27 | 3.5 | 43.06 | 60.12 | 33.43 | 4-5 |
| Red | 15 | 25 | 4.6 | 29.02 | 60.21 | 38.04 | 4-5 |

### Example 7

In another method of preparing pigmented master batch, the pigment is dispersed in cellulose pulp with target cellulose concentration in the range 0.5-5% (w/w) and pigment concentration in the range 0.4-12.6% (w/w). 0.3% propyl gallate added as antioxidant. This master batch with cellulose and pigment was prepared to provide mixing consistency with regular dope. The master batch was mixed with regular dope of 13% cellulose in NMMO to make dyed dope for spinning. Fibre spinning performance was good. Master batch can be mixed with regular dope in continuous production line using static/ dynamic mixer. For achieving 2% black pigment in fibre, master batch of 8% Pigment & 5% cellulose in NMMO monohydrate was mixed with regular dope in ratio of 30:1 (regular dope to master batch). To prepare master batch 3.39% cellulose, 5.4% VBL black pigment 55.17% NMMO and rest water were mixed in sigma mixer with very high shearing. 0.3% of propyl gallate with respect to cellulose concentration was also added. Excess water was removed from the mixture by applying vacuum of 50-100 Torr at temperature of 90-105° C. to make black pigmented dope containing 5% Cellulose, 8% VBL in NMMO monohydrate.

Colour properties of 2% and 3.5% pigment loaded dyed fibres spun by above mentioned master batch approach are shown in Table 5. Similar fibre properties were observed for both fibres with excellent colour fastness.

TABLE 5
Properties of fibre prepared by master batch with pigment and cellulose

| | | | | | | | | Colour |
|---|---|---|---|---|---|---|---|---|
| | | | Mixing | | | | | fastness |
| | | Pigment | ratio | Pigment | | | | (ISO: 105 |
| Colour | % Cellulose | in MB (%) | (control:MB) | in fibre (%) | L | a | b | C10-2006 (B2)) |
| Black | 5 | 8 | 30 | 2 | 18.51 | 1.22 | 0.23 | 4-5 |
| Black | 0.5 | 12.5 | 27 | 3.5 | 12.78 | 0.09 | −0.34 | 4-5 |

The embodiments were chosen and described in order to best explain the principles of the present invention and its practical application thereby enabling others, skilled in the art, to best utilize the present invention and various embodiments with various modifications as are suited to the particular use contemplated.

1. A process for obtaining a dope dyed lyocell fibre, comprising the steps of:
(a) mixing one or more pigment with an aqueous organic solvent to obtain a slurry;
(b) applying vacuum at a predetermined temperature to said slurry to remove excess water content to obtain a masterbatch comprising 8-15% water and 0.4 to 15% pigment
(c) mixing the masterbatch obtained in step (b) to a lyocell dope to obtain a pigmented dope; and
(d) extruding said pigmented dope of step (c) through a spinneret to form dope dyed lyocell fiber.

2. The process as claimed in claim 1, wherein said aqueous organic solvent is N-methylmorpholine-N-oxide.

3. The process as claimed in claim 1, wherein the pigment is at least one color pigment selected from group consisting of green, blue, red, black and/or yellow pigments.

4. The process as claimed in claim 1, optionally comprises of adding 0.5 to 5% w/w of cellulose pulp in step (a).

5. The process as claimed in claim 1, wherein the lyocell dope comprises of cellulose pulp dissolved in N-methylmorpholine-N-oxide.

6. The process as claimed in claim 1, wherein mixing of step (c) is carried out using a high shear mixer.

7. A dope dyed lyocell fibre prepared by process of claim 1, having an elongation at break in the range of 10 to 15 percent.

8. A dope dyed lyocell fibre prepared by process of claim 1, having a color fastness in the range of 4-5.

9. A process for preparing a dope dyed lyocell fibre, as claimed in claim 1 comprising the steps of:
a. preparing a cellulosic dope by mixing cellulose pulp and at least one pigment in an aqueous organic solvent; and
b. allowing evaporation of said cellulosic dope to remove excess water content to obtain a pigmented dope.
c. extruding the pigmented dope through a spinneret to form dope dyed lyocell fiber.
